(19) United States
(12) Patent Application Publication
(10) Pub. No.: US 2009/0238624 A1
(43) Pub. Date: Sep. 24, 2009

(54) SHEET MATERIAL INFORMATION DETECTION APPARATUS, SHEET MATERIAL PROCESSING APPARATUS, AND SHEET MATERIAL INFORMATION DETECTION METHOD

(75) Inventors: Takehiko Kawasaki, Kamakura-shi (JP); Norio Kaneko, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/300,718

(22) PCT Filed: Jun. 13, 2007
(86) PCT No.: PCT/JP2007/062360

§ 371 Date: Nov. 13, 2008

(30) Foreign Application Priority Data
Jun. 20, 2006 (JP) 2006-170769

(51) Int. Cl. G03G 15/00; G01N 3/30; G01B 11/14; G01P 3/36

(52) U.S. Cl. 399/407; 73/12.01; 356/614; 356/28

(57) ABSTRACT

A motion member (1) urged by an application spring 4 is made to collide with a surface of a sheet material supported by a support member (14) so as to be deflectable and deformable. The velocity of the motion member (1) during the collision process is detected every second by a measuring portion (17) of a laser Doppler velocimeter. A control circuit (121) measures the velocity of the motion member (1) immediately before the collision of the motion member (1) with the sheet material, the time period of deflection deformation until the sheet material collides with an opposing member (15), and the time period of compression deformation after the collision of the sheet material with the opposing member (15), and outputs a result thereof as sheet material information to a control portion (120). The timing at which the sheet material collides with the opposing member (15) is detected by an output of a piezoelectric element (16) connected to the opposing member (15).

### TECHNICAL FIELD

The present invention relates to a sheet material information detection apparatus which allows a motion member to collide with a sheet material to generate an output by which the sheet material can be identified, and more particularly, to a mechanism for detecting an impact force through a sheet material. Further, the present invention relates to a sheet material processing apparatus and a sheet material information detection method.

### BACKGROUND ART

In recent years, in a technical field of sheet material processing apparatuses, typified by image forming apparatuses (such as LBPs, copying machines, and inkjet printers), the diversification of types of sheet materials to be processed has proceeded, and the diversification of users and use environment of the sheet material processing apparatus has also proceeded. As far as the image forming apparatus is concerned, for the thus diversified sheet materials, there is an increasing need for improvement of quality (higher image quality, higher processing speed, and the like). On the other hand, with the diversification of sheet materials and the diversification of processing contents, the number of items to be set by a user becomes enormous, thereby making it difficult to set the optimum processing conditions. Therefore, a technique, in which various kinds of sensors are disposed in a sheet material processing apparatus to automatically identify sheet material information including the size, thickness, and material of the sheet material, and automatically set the optimum processing conditions, is put into practical use in some cases.

Japanese Patent Application Laid-Open No. 2005-024550 discloses a sheet material information detection apparatus in which an impact application member is made to collide with a sheet material and an impact through the sheet material is detected by a piezoelectric element. In this technique, a voltage output of the piezoelectric element which is deformed by receiving the impact is detected, and a peak value of the detected voltage output is determined to specify the kind of the sheet material. The piezoelectric element is interposed between an impact reception member and a cushioning member, and the impact received by the impact reception member through the sheet material is detected by the piezoelectric element.

Japanese Patent Application Laid-Open No. 2004-38983 discloses a system in which various sheet material informations including texture, glossiness, ink absorbability, luminance, gross, color reflection, color depth, granularity, whiteness, humidity, heat loss, adhesiveness, and adherence are databased and shared by a plurality of printers. When a sheet material is designated through a setting screen, necessary sheet material information is taken out from the database to a selected printer, and processing conditions optimized based on the sheet material information is automatically set to the printer.

Japanese Patent Application Laid-Open No. 2002-310866 discloses a sheet material information detection apparatus in which a compression impact force is made to act on a sheet material interposed between a pair of members having high rigidity to detect sheet material information. In this technique, the impact compression force is transmitted from a one member side to the sheet material, whereby an impact compression force corresponding to the compression characteristics and attenuation characteristics of the sheet material is detected by a piezoelectric element disposed on the other member.

Japanese Patent Application Laid-Open No. 10-152245 discloses an image forming apparatus having a sheet material information detection apparatus disposed in a sheet material transport path. In this technique, a displacement of a member which has been brought into contact with the sheet material passing through the transport path is measured to determine the specific resistance and water content of the sheet material.

With the sheet material information detection apparatus disclosed in Japanese Patent Application Laid-Open No. 2005-024550, by detecting the impact force through a sheet material, the mechanical properties of the sheet material such as elastic coefficient and attenuation coefficient can be detected with high reproducibility and accuracy while fully complying with high speed transportation.

However, when a combination of a motion member, an acceleration mechanism of the motion member, and an impact reception member (support member) is determined, the range of sheet materials which can be detected with high accuracy will be limited. For example, a lightweight motion member optimized for a thin sheet material will rebound from a surface of an extremely thick sheet material, so that an impact does not reach the impact reception member. However, when the motion member is made heavier or the collision velocity is made higher, a large impact force ignoring a deflection resistance of the thin sheet material is detected, so that the thin sheet material cannot be identified with high accuracy. Further, there is a fear that a trace of collision may be left on the sheet material.

With the system as disclosed in Japanese Patent Application Laid-Open No. 2004-38983, an arithmetic operation is performed by accessing a database and obtaining necessary data, so that it takes a long period of time to set conditions for processing the sheet material. Accordingly, the system is not suitable for real-time processing in which processing conditions are set for each sheet material to be processed.

With the sheet material information detection apparatus as disclosed in Japanese Patent Application Laid-Open No. 2002-310866, in order to apply a compression force to a large area of a sheet material, a heavy large hitting member is needed. Further, because an operation of interposing the sheet material between the pair of members is required, it takes time. Therefore, when the sheet material information detection apparatus is arranged on the sheet material transport path to perform a test for each sheet material, the test lags behind high-speed transportation of the sheet material.

Since the sheet material information detection apparatus disclosed in Japanese Patent Application Laid-Open No. H10-152245 only rubs a surface of a sheet material, the mechanical properties of the sheet material such as a deflection resistance, a compression resistance, and attenuation performance cannot be determined. Application of a large pressure may damage the sheet material. Accordingly, in a case of using a sheet material having a low flaw resistance, such as glossy paper, an allowable pressure range for the sheet material information detection apparatus is limited, so that the detection accuracy of sheet material information may be lowered.

Further, in the sheet material processing apparatus, in steps such as transportation, fixation/pressing, or the like for the sheet material, a mechanical operation involving load application with respect to the sheet material for deflection and compression is performed. Further, in recent years, the mechanical operation with respect to the sheet material has been performed at a higher speed in response to a demand for higher processing speed. Therefore, in order to carry out optimization by adjusting operation settings for the mechanical operation, detection of characteristics related to dynamic behavior of the sheet material becomes necessary. As described in “Pulp and Paper” edited by The Japan Wood Research Society, published by Buneido Publishing Co., Ltd., 1991, a sheet material such as paper has a viscoelastic characteristic, and dynamic behavior in deflection deformation or compression deformation depends on a load application speed due to correlation between the load application and a relaxation phenomenon.

As a result, in order to obtain information useful for processing the sheet material, information on load application speed in the load application is important. However, in the above-mentioned prior art, information on characteristics related to a dynamic behavior in deflection deformation and compression deformation of the sheet material cannot sufficiently be obtained.

### DISCLOSURE OF THE INVENTION

The present invention provides a sheet material information detection apparatus, which can cope with high-speed transportation of a sheet material and can obtain sheet material information of high accuracy from the sheet material with a wide range of mechanical properties.

Preferably, the present invention provides a sheet material information detection apparatus which allows a relatively lightweight motion member to collide with a sheet material at a relatively low collision speed to thereby obtain sheet material information of high accuracy also from a sheet material having a relatively high deflection resistance.

More preferably, the present invention provides a sheet material information detection apparatus which includes mechanism portions (motion member, acceleration mechanism, and support member) used in common with the conventional sheet material information detection apparatus and in which sheet material information of high accuracy can be obtained for a wider range of mechanical properties of a sheet material.

According to the present invention, there is provided a sheet material information detection apparatus, which includes a motion member movably supported and having a collision surface, formed thereon, for colliding with a sheet material, and a support member for supporting the sheet material so as to face the collision surface, in which the motion member is allowed to collide with the sheet material supported by the support member. The apparatus further includes a motion detection unit for detecting at least one of position and velocity of the motion member during the process of collision with the sheet member, and an output unit for detecting an output of the motion detection unit during the collision process and outputting sheet material information.

With the sheet material information detection apparatus according to the present invention, the behavior of a sheet material surface to which an impact has been applied is tracked by the motion member, and the motion detection unit picks up the resultant as the velocity or displacement of the motion member. Accordingly, the momentum (velocity×mass) when the motion member collides with the sheet material and the behavior (deformation amount, deformation time, and deformation process, etc.) of the sheet material surface due to the collision can be detected more directly and correctly than in the apparatus disclosed in Japanese Patent Application Laid-Open No. 2005-024550. Thereby, the elasticity and attenuation performance involved in bending and compression of a sheet material can be evaluated more accurately than the conventional techniques.

With the sheet material information detection apparatus according to the present invention, even in “a case where the motion member is bounced by a surface”, an output reflecting the mechanical properties of a sheet material can be obtained as information to velocity change or displacement. According to the present invention, even in a case where the momentum of the motion member is excessively small (a sufficient impact force is not detected), as the information to the velocity or displacement, the deflection resistance or rigidity of a sheet material can be identified with high accuracy (see FIG. 7). By allowing a relatively lightweight motion member to collide with a sheet material at a relatively small collision velocity, the duration time of the collision process, which can be detected, can be extended to improve the measurement accuracy.

The sheet material information detection apparatus according to the present invention is useful from the viewpoint of cost because the apparatus can include many of the mechanism portions (motion member, acceleration mechanism, and support member) which are common to those of the conventional sheet material information detection apparatus such as disclosed, for example, in Japanese Patent Application Laid-Open No. 2005-024550. As a result, detection can be selected, in which through a common impact application using the motion member, sheet material information can also be obtained by the conventional sheet material information detection apparatus in parallel to the present sheet material information detection apparatus.

The sheet material information detection apparatus according to the present invention exhibits an excellent effect as described above even when the sheet material information detection apparatus is used alone for detecting at least one of the velocity and displacement of the motion member. However, with an arrangement and control in which, through utilization of commonality of the above-mentioned mechanism portions and the shared impact application, the sheet material information detection apparatus of the present invention is provided together with the sheet material information detection apparatus disclosed in Japanese Patent Application Laid-Open No. 2005-024550, a more superior effect is exhibited. The sheet material information detection apparatus of the present invention and the sheet material information detection apparatus according to Japanese Patent Application Laid-Open No. 2005-024550 can obtain the sheet material information in parallel or complementarily to each other, and can also mutually use outputs from those as timing signals.

Further features of the present invention will become apparent from the following description of exemplary embodiments with reference to the attached drawings.

### BRIEF DESCRIPTION OF THE DRAWINGS

FIG. 1 is an explanatory diagram of a structure of an image forming apparatus.

FIG. 2 is an explanatory view of a structure of a sheet material information detection apparatus according to a first embodiment of the present invention.

FIGS. 3A, 3B, 3C and 3D are explanatory diagrams illustrating a collision process of a motion member.

FIG. 4 is a graphical representation illustrating a result of detection by a motion detection portion.

FIG. 5 is a flow chart illustrating an operation of a sheet material information detection apparatus.

FIG. 6 is a flow chart illustrating a control of a sheet material processing apparatus according to a second embodiment of the present invention.

FIG. 7 is a table showing sheet material information outputs using a measuring portion and a piezoelectric element.

FIG. 8 is an explanatory view of a structure of a sheet material information detection apparatus according to a third embodiment of the present invention.

### BEST MODES FOR CARRYING OUT THE INVENTION

Hereinafter, detailed description will be made of a sheet material information detection apparatus 100 according to an embodiment of the present invention with reference to the attached drawings. The sheet material information detection apparatus according to the present invention is not limited to a limitative structure according to embodiments described below. As long as a sheet material is identified by allowing a motion member to collide with a sheet material, other embodiments may be realized, in which a part or the whole of structures of the embodiments may be replaced with an alternative structure.

In this embodiment, description is made of an example in which a sheet material information detection apparatus 100 is mounted on an electrostatic image forming apparatus 300, and sheet material information obtained based on an impact force and sheet material information obtained based on velocity are utilized in combination with each other. However, the sheet material information detection apparatus 100 of this embodiment may be mounted on an inkjet image forming apparatus, various printing apparatuses, a sheet material processing device, a sheet material stacking devices, a sorter, or the like. There may be adopted a control in which sheet material information is obtained based only on velocity (or position).

Incidentally, the above-mentioned structure, operation, control, operation principle of the sheet material information detection apparatus, signal processing, and the like of the image forming apparatus disclosed in the prior art documents described above will not be illustrated in the drawings and descriptions thereof will also be omitted to avoid complication due to repetition.

### First Embodiment

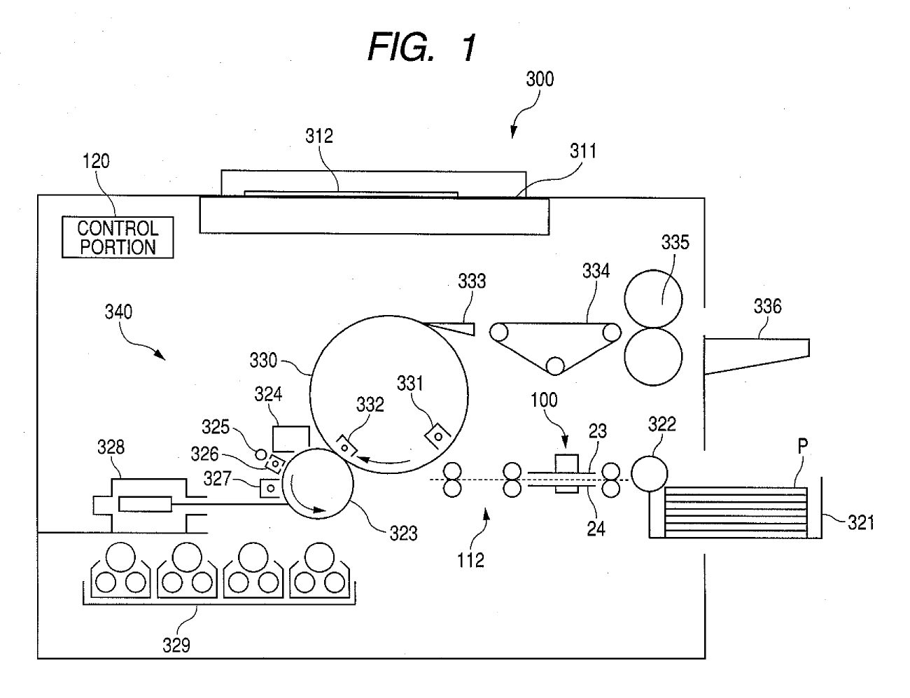

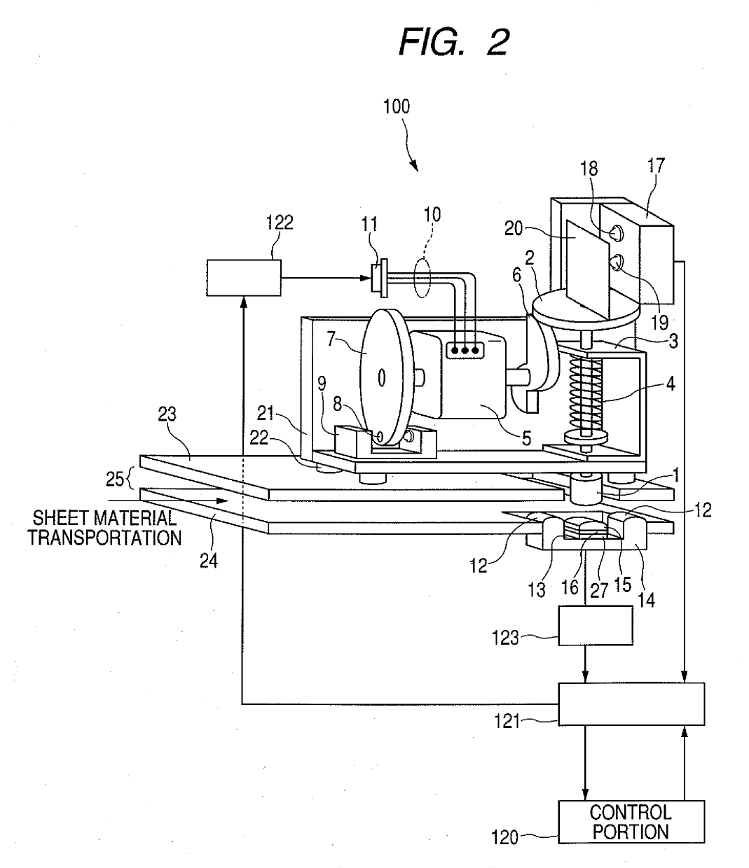

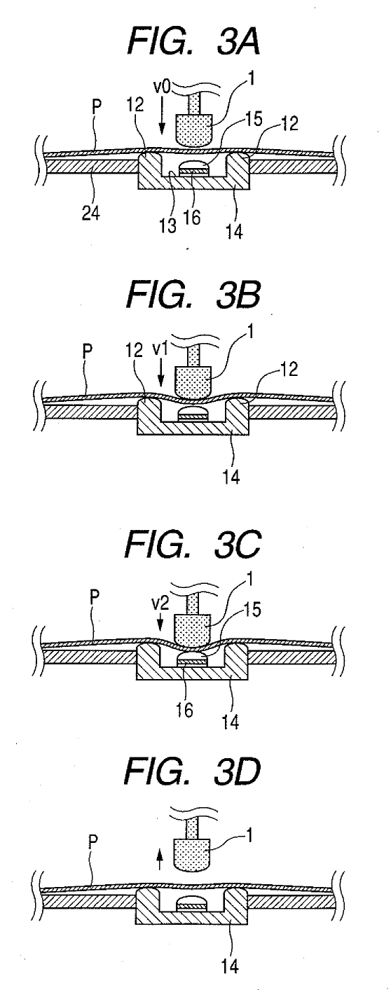

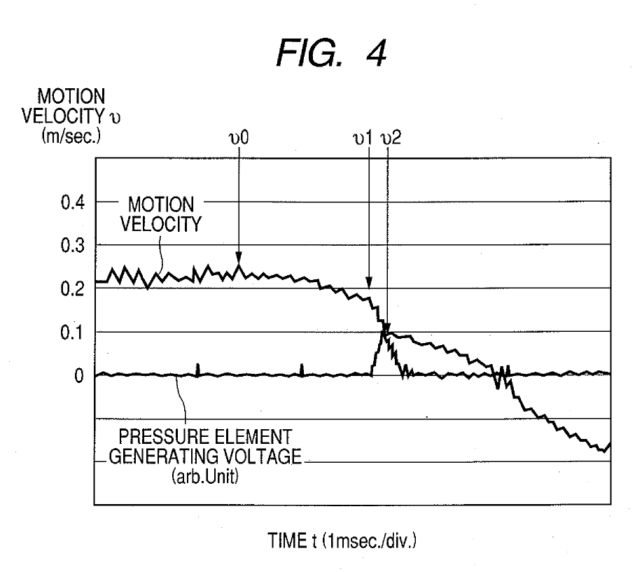

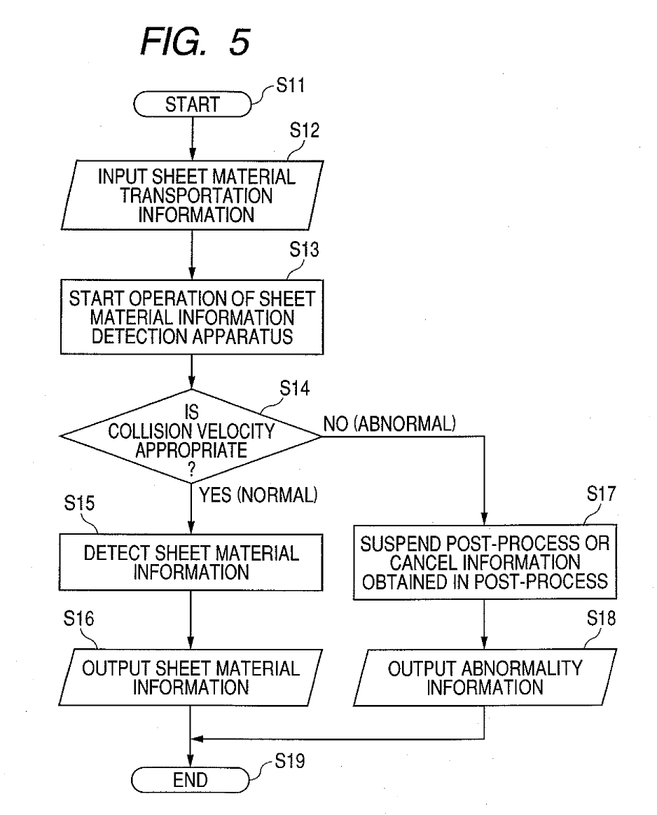

FIG. 1 is an explanatory diagram of a structure of an image forming apparatus. FIG. 2 is an explanatory view of a structure of a sheet material information detection apparatus according to a first embodiment of the present invention. FIGS. 3A to 3D are explanatory diagrams illustrating a collision process of a motion member. FIG. 4 is a graphical representation of a result of detection by a motion detection portion. FIG. 5 is a flow chart illustrating an operation of the sheet material information detection apparatus.

As illustrated in FIG. 1, an image forming apparatus 300 is a color copying machine for performing image formation on a sheet material P by an image formation process portion 340. A reading unit 311 reads mage information of a color original 312. The read information is converted into color signals corresponding to four colors of toner, which are cyan, magenta, yellow, and block.

On the other hand, the sheet material P accommodated in a cassette 321 is sent to a transporting portion 112 by a transmission roller 322. In a position adjacent to the transporting portion 112, there is provided the sheet material information detection apparatus 100. The sheet material information detection apparatus 100 is arranged so as to interpose, from above and below, the sheet material P to be passed from the transmission roller 322 to the transporting portion 112, in a transporting position. The sheet material information detection apparatus 100 detects sheet material information (mechanical characteristics) of the sheet material P passing therethrough.

A control portion 120 identifies the sheet material information to the sheet material P detected by the sheet material information detection apparatus 100 before the image formation is performed by the image formation process portion 340, and sets optimum transporting conditions, transfer conditions, fixing conditions, or the like.

Next, the sheet material P is sent to the transfer device drum 330. The peripheral surface of the transfer device drum 330 is provided with a dielectric sheet. The sheet material P is attracted and carried on a surface of the transfer device drum 330 charged by an attracting corona discharger 331. After that, in the image formation process portion 340, due to an action of the attracting corona discharger 331, a toner image on a photosensitive drum 323 is transferred to a sheet material P.

The surface of the photosensitive drum 323 is cleaned by a blade cleaner 324. A pre-exposure lamp 325 and a pre-charge-eliminator 326 eliminate an effect remaining on a photosensitive member surface layer due to the last image formation. Next, the surface of the photosensitive drum 323 is uniformly charged by a primary charger 327. The amount of charge at this time is determined based on the sheet material information on the sheet material P detected by the sheet material information detection apparatus 100.

A laser beam scanner 328 scans the surface of the photosensitive drum 323 to form an electrostatic latent image based on the color signals of the color original 312 obtained by reading. A developing device 329 includes developing units of four colors, which are cyan, magenta, yellow, and black. The developing units corresponding to respective colors successively move to a position directly below the photosensitive drum 323 to develop the latent image on the photosensitive drum 323 to a toner image.

The sheet material P is attracted and carried on the transfer device drum 330 until the toner image of four colors is successively transferred. After that, the sheet material P is separated from the transfer device drum 330 by an action of a separation claw 333. The separated sheet material P is sent to a heating roller fixing device 335 by a conveyor belt 334 and heat and pressure are applied thereto, so that a toner image is fixed onto a surface of the sheet material P. The fixing temperature at this time is determined based on sheet material information on the sheet material P detected by the sheet material information detection apparatus 100.

The sheet material P after completion of the fixation is discharged onto a tray 336. A toner remaining on the surface of the photosensitive drum 323 after completion of the transfer is cleaned by the blade cleaner 324, and a process advances to a next image formation cycle.

As illustrated in FIG. 2, in the sheet material information detection device 100, a motion member 1 is made to protrude and collide with the surface of the transported sheet material, and the motion of the motion member 1 during the collision process is measured by a measuring portion 17. The sheet material is supported by a support member 14. The motion member 1 is constantly urged toward the surface of the sheet material by an application spring 4, and is pushed up by a mechanism using a motor 5 and a cam 6 to be released. FIG. 2 schematically illustrates a state where the application spring 4 is compressed and the motion member 1 is in a suspended state.

The motion member 1 is supported by a bearing 3 so as to be movable in the vertical direction in FIG. 2. An upper end of the motion member 1 is fixed to a disk plate 2 used for interlocking with an acceleration mechanism. The acceleration mechanism includes the application spring 4 for applying an acceleration force, the motor 5 for expanding and compressing the application spring 4, and the cam 6 fixed to an output shaft of the motor 5, and gives the motion member 1 a predetermined collision velocity.

On an opposite side of the output shaft of the motor 5, a positioning mechanism used for adjustment of a rotation angle of the motor 5 is positioned. The positioning mechanism includes a positioning wheel 7 having a through-hole 8 formed therein for position detection and fixed to the output shaft of the motor 5, and a photointerrupter 9 for detecting the through-hole 8.

The motor 5 is supplied with a drive electrical power from a driver 122 through a connector 11 and an electric wire 10. The driver 122 controls the rotation angle and rotation speed of the motor 5 based on a control signal input from a control circuit 121. The control circuit 121 controls the motor 5 with reference to an output of the photointerrupter 9, and allows the motion member 1 to protrude onto the sheet material at a timing instructed by the control portion 120 of the image forming apparatus 300.

The measuring portion 17 measures the position of the motion member 1 as a measuring object every second and outputs, to the control circuit 121, a voltage signal corresponding to velocity. For the measuring portion 17, a laser Doppler velocimeter having a high speed following ability is adopted. The measuring portion 17 includes a light source 18 for outputting a laser beam and a light receiving portion 19 for detecting light reflected by a reflection plate 20, and detects a frequency shift corresponding to the motion velocity of the reflection plate 20.

The control circuit 121 includes therein a high-speed analogue waveform analyzer, detects an output of the measuring portion 17, and analyzes a velocity change. The control circuit 121 starts capturing an output of the measuring portion 17 in synchronization with the protrusion (or strike) of the motion member 1, detects a velocity change of the motion member in the collision process, and outputs a detection result to the control portion 120. The control portion 120 illustrated in FIG. 1 identifies the sheet material based on the detection result of the control circuit 121 and adjusts the moving speed of the sheet material and various processing conditions in the image formation process portion.

To the plate 2 fixed to the upper end of the motion member 1, the reflection plate (auxiliary measuring member) 20 is fixed which reflects light from the light source 18 for aiding the measurement. The motion member 1, the acceleration mechanism, and the measuring portion 17 are assembled in a housing 21 which is attached to a first transportation guide 23 through a damper 22.

The first transportation guide 23 is opposed to a second transportation guide 24, and a gap therebetween constitutes a transport path 25 for a sheet material. To the second transportation guide 24, a support member 14 is attached through a damper member (not shown). The sheet material is transported in the transport path 25 from the left side to the right side in FIG. 2, and the motion member 1 is made to protrude onto the sheet material in a state where the sheet material is supported by the support member 14 so as to be deformable.

The support member 14 for supporting the sheet material is formed with a recess 13 allowing deflection of the sheet material between two protrusions 12. In a position in the recess 13, which is opposed to the motion member 1, an opposing member 15 for receiving the motion member 1 through the sheet material is disposed. The opposing member 15 is bonded and fixed integrally to the support member 14 such that the opposing member 15 and a spacer 27 which is fixed to the recess 13 of the support member 14 interpose a piezoelectric element 16 therebetween. A change in the electric capacity of the piezoelectric element 16 is converted to a voltage signal by an output circuit (charge amplifier) 123 and taken into by the control circuit 121.

The control circuit 121 detects a peak value of an impact force (output of piezoelectric element 16) applied by two times of strikes for one cycle using the motion member 1 and outputs the detected value to the control portion 120. The control portion 120 illustrated in FIG. 1 identifies the sheet material not only based on the velocity change detected by the measuring portion 17 but also based on the peak value of the impact force. Further, as described below, the piezoelectric element 16 detects a timing at which detection of the impact force is started, and allows the measuring portion 17 to start measuring the compression process.

The motion member 1 has a distal end portion (side to be brought into contact with the sheet material P), a shaft portion passing through the application spring 4, and the plate 2 engaged with the cam 6, which are integrated with each other. The distal end portion is made of a stainless steel material, and a contact surface thereof to be brought into contact with the sheet material is applied with a spherical machining so as to have a radius of 20 mm. The total mass of the motion member 1 is 4 g including the shaft and the plate 2.

The mass of the motion member 1 is appropriately determined based on the sheet material to be detected. In a case where the present invention is applied to communication paper having a sheet-material thickness of about 50 μm to 250 μm, the mass of the motion member 1 can be within the range from 1 g to 20 g. In a case where the sheet material has a large thickness and high rigidity, the mass thereof can be made large. In a case where the sheet material has a small thickness and small rigidity, the mass thereof can be made small. In the present invention, as described below, as compared to Japanese Patent Application Laid-Open No. 2005-024550, the allowable range of the sheet material with respect to the mass of the motion member 1 is substantially wide.

The motion member 1 is held by the bearing 3 at upper and lower portions of the intermediate shaft portion thereof and is linearly movable in the vertical direction. The bearing 3 is made of a resin material having a low friction resistance, and in the first embodiment, a fluorinated resin is used.

The motor 5 repeats an operation of rotating the cam 6 by a requisite angle and then stopping the cam 6 in a process in which the motor 5 makes one rotation from a predetermined stop position, and lastly returns the cam 6 to an original stop position. A stepping motor is used as the motor 5. The cam 6 performs compression/release of the application spring 4 for two times in a process in which the cam 6 makes one rotation, and pushes up the motion member 1 and subjects the motion member 1 to urging by the application spring 4. The motion member 1 driven by a restring force of the application spring 4 and accelerated to a predetermined collision velocity collides with the sheet material, thereby deflecting and deforming the sheet material.

The collision velocity of the motion member 1 is appropriately determined in consideration of the sheet material to be detected and load application conditions in the image forming apparatus 300.

More desirably, the collision is made such that the motion member 1 collides with the sheet material at least once at a collision velocity higher than a load application velocity in the image forming device 300 and at least once at a collision velocity lower than the load application speed, thereby performing detection of sheet material information. On the basis of the sheet material information obtained at the high collision velocity and the sheet material information obtained at the low collision velocity, the velocity dependency of the dynamic behavior of the sheet material can be determined.

In the first embodiment, the cam 6 has two lifts to cause two times of collisions in one rotation. The respective lifts of the cam 6 have different distances from a rotation center. Therefore, the amounts of compressions of the application spring 4 by the respective lifts are different, with the result that the motion member 1 is given different collision velocities at the respective collisions. In the first embodiment, the transportation of the sheet material is controlled at a transportation speed of 0.3 m/sec. Therefore, it is designed such that the collision velocity at a first time is 0.4 m/sec and the collision velocity at a second time is 0.23 m/sec. The rotation of the cam 6 caused by the motor 5 includes a step of temporarily stopping the rotation at a midpoint of the rotation in order to attenuate unnecessary vibration occurring involved in driving.

The positioning wheel 7 fixed to the output shaft of the motor 5 is provided with the through-hole 8 for detecting the stop position. When the cam 6 reaches the stop position, the photointerrupter 9 detects the through-hole 8. The stop position of the cam 6 is set to a position at the time at which the application spring 4 is compressed to a maximum degree in the process of one rotation of the cam 6 and just after which the application spring 4 is released. When the cam 6 is led to the stop position, the motion member 1 is most distant from the sheet material.

In the first embodiment, the process in which the cam 6 releases the plate 2 at a predetermined rotation angle to protrude the motion member 1 by the application spring 4 is successively performed twice. One cycle begins from rotation start of the cam 6 at the stop position and ends at returning of the cam 6 to the stop position again after one rotation. In the present embodiment, it is designed such that it takes 0.2 second for one cycle and an interval between two times of strikes is 0.1 second. The start of one cycle is set to a time after a predetermined time from reception of a signal from a sheet material passage detection sensor (not shown) disposed in the sheet material transport path 25.

The entirety of the support member 14 is made of a high-rigidity resin. A part of the surface of the protrusion 12 to be brought into contact with the sheet material has a stainless steel plate bonded thereto. The protrusion 12 has a surface moderately curved in a transporting direction of the sheet material, thereby avoiding frontal clash of an edge thereof with the sheet material.

A stainless steel material is used for the opposing member 15, and on the surface thereof opposed to the motion member 1 is provided with the same curved surface as that of the distal end of the motion member 1. Between the protrusion 12 of the support member 14 and the opposing member 15, there is provided a step structure in which a top of the protrusion 12 and a top of the opposing member 15 have a height difference of 0.3 mm. The support member 14 supports the sheet member by the protrusions 12, and allows deflection of the sheet material by the step structures, and receives the motion member 1.

The piezoelectric element 16 is positioned under the opposing member 15. The piezoelectric element 16 generates an output when the motion member 1 comes into contact with the opposing member 15 through the sheet material. Therefore, the piezoelectric element 16 is used for detecting the contact timing.

Incidentally, as the measuring portion 17, various elements or components other than a reflective element having the light source 18 and the light receiving portion 19 can be adopted as long as it can measure the motion of the motion member 1. The combination of the light source 18, the light receiving portion 19, the reflection plate 20, and members used for an accompanying optical system and data processing system is not particularly limited and may include various structures. In the first embodiment, description will be made by taking, as an example, a system using a laser Doppler velocimeter which is a velocimeter for detecting the interference of laser light. The laser Doppler velocimeter can directly measure a moving speed of the reflection plate 20 with high accuracy in real time.

As other examples which can be adopted as the measuring portion 17, there may be included a method of measuring velocity by tracking a marking or a scale provided to a reflection plate, and a method of measuring a moving position according to increase/decrease of the amount of reflected light involved in the movement of the reflection plate 20, with the structure shown in FIG. 2. Further, there may be adopted various encoders for measuring a coordinate position by reading a magnetic pattern or an optical pattern.

FIGS. 3A to 3D illustrate one collision process in time series fashion, with the structure according to the first embodiment, in which the motion member 1 is made to collide with the sheet material to generate deflection deformation and compression deformation of the sheet material. In FIGS. 3A to 3D, FIG. 3A illustrates a state before the collision, FIG. 3B illustrates a state immediately after the collision, FIG. 3C illustrates a collision detection state, and FIG. 3D illustrates a repulsing state. FIGS. 3A to 3D illustrate results obtained by analyzing images taken by high-speed shooting with a high speed camera FASTCAM-512PCI (trade name; manufactured by PHOTORON LIMITED). Here, the figures are depicted such that the sheet material information detection apparatus 100 illustrated in FIG. 2 is viewed from the downstream side of the transport path 25 and only a minimum structure required for the description is illustrated.

As illustrated in FIG. 3A, the motion member 1 is accelerated to a predetermined collision velocity (v0) and collides with the sheet material P. The sheet material P is transported by the transporting roller (not shown) so as to be pressed against the protrusions 12 of the support member 14. With respect to a tensile force caused by the impact application as in the first embodiment, the protrusions 12 function substantially as fixed ends owing to a frictional force.

As illustrated in FIG. 3B, when the motion member 1 collides with the sheet material P, the sheet material P is supported by the protrusions 12 of the support member 14 to be deflected while being held at both sides of the deflected part thereof. In the process of the deflection deformation, the motion member 1 decelerates by meeting with resistance of the spring force during the deflection deformation of the sheet material P. The deceleration process due to the deflection deformation of the sheet material P ends when the velocity of the motion member 1 becomes 0 due to the resistance of the spring force or when the sheet material P collides with the opposing member 15.

When the resistance of the sheet material is superior to the momentum of the motion member 1, the process proceeds to the rebound process illustrated in FIG. 3D before the sheet material P collides with the opposing member 15. When the momentum of the motion member 1 is superior to the resistance of the sheet material P, the velocity at the end of the deflection deformation (v1) is more than 0, so that the process proceeds to the compression process illustrated in FIG. 3C.

Accordingly, the control circuit 121 detects the output of the measuring portion 17 and detects a velocity change in the deflection deformation process of the sheet material, thereby enabling identification of the dynamic behavior of the sheet material P through deflection deformation. Based on the velocity of the motion member 1 detected by the measuring portion 17, the start of the deflection deformation process can be detected. The control circuit 121 illustrated in FIG. 2 detects the output of the measuring portion 17 to measure the time period from the start of the deflection deformation of the sheet material to the end thereof. As a result, even in a case where the sheet material P does not collide with the opposing member 15, that is, a case where the piezoelectric element 16 does not detect an impact force, the spring force and deflection resistance of the sheet material P can be measured.

As a matter of course, in the deflection deformation process of the sheet material P illustrated in FIG. 3B, there is transmission of a force, which presses the protrusions 12 downwardly, from the motion member 1 to the protrusions 12 through the sheet material P. However, members including peripheral members have compression rigidity extremely larger than the deflection rigidity of the sheet material, so that in the deflection deformation process, the deformation of the peripheral members can be disregarded. However, in the compression deformation process, the deformation of the peripheral members cannot be disregarded, so that the velocity (v2) at the end of the compression deformation process is not necessarily 0 (see FIG. 4). Therefore, the end of the compression deformation process cannot be determined based on the output of the measuring portion 17. Accordingly, in the first embodiment, the control circuit 121 (FIG. 2) detects the output of the piezoelectric element 16 to determine the times of the start and end of the compression deformation process and arithmetically operates the duration time of the compression deformation process. In the compression deformation process, the output voltage is generated by the piezoelectric element 16, so that information as to the collision timing can be obtained by sensing the output voltage.

The control circuit 121 (FIG. 2) detects the output of the measuring portion 17 to determine the velocity at the end of the deflection deformation (v1) and determines the duration time of the compression deformation process based on the output of the piezoelectric element 16. Based on the velocity at the end of the deflection deformation (v1) and the duration time of the compression deformation process, the sheet material information related to the thickness, compression elasticity, compression rigidity, and the like of the sheet material P is obtained. In other words, by detecting the velocity change in the compression deformation process of the sheet material, the dynamic behavior of the compression of the sheet material P is detected.

When the compression process ends, the process proceeds to the rebound process illustrated in FIG. 3D. The motion member 1 starts a reverse motion by receiving repulsion of the sheet material P, the opposing member 15, and the like. The control circuit 121 (FIG. 2) measures the velocity of the motion member 1 in the rebound process, and a comparison is made between the velocity and the collision velocities (v0 and v1), thereby obtaining sheet material information related to the coefficient of rebound, coefficient of attenuation, tan δ, and the like of the sheet material.

The control portion 120 of the image forming apparatus 300 illustrated in FIG. 1 receives a plurality of sheet material informations which are detected by various methods as described above from the control circuit 121 every time when two times of protrusions (strikes) of the motion member 1 in one cycle end. Of the plurality of sheet material informations, one(s) having low accuracy are discarded. Based on majority rule, according to the identification results of the sheet material based on the sheet material information having high accuracy, ultimate identification results are prepared.

Desirably, the motor 5 is activated in the rebound process so that the motion member 1 is pulled up by the cam 6 before starting next reverse falling, thereby preventing the motion member 1 from colliding again with the sheet material.

The measurement results obtained by using the measuring portion 17 and the piezoelectric element 16 in the process of collision of the motion member 1 with the sheet material are illustrated in FIG. 4. For the sheet material as an object of collision, CLASSIC Laid Text paper 701b (trade name; manufactured by Neenah Paper Inc.) was used. In FIG. 4, there is shown a state where the motion member 1 reaches the predetermined collision velocity (v0), collides with the sheet material and rebounds. In FIG. 4, there is also illustrated the change in movement velocity of the motion member 1 in the collision process and the voltage generated by the piezoelectric element at that time.

The collision velocity (v0) is 0.23 m/sec. The collision velocity decelerates at about 1.3 m/sec through the subsequent deflection deformation process of the sheet material until the collision velocity reaches the speed at the end of the deflection deformation process (v1), that is, 0.17 m/sec. Subsequently, the collision velocity decelerates at about 0.2 m/sec through the compression deformation process until the collision velocity reaches the speed at the end of the compression deformation process (v2), that is, 0.09 m/sec.

In the compression deformation process of the sheet material, at the start of the compression deformation process, the impact force is transmitted to the piezoelectric element included in the opposing member, thereby generating a voltage. Further, the motion member 1 is somewhat decelerated by the peripheral members or the like, and is then bounced, to thereby end the collision process. According to data of FIG. 4, the deflection spring constant at the above-mentioned velocity of the sheet material P was evaluated to be about 5000 N/m.

With reference to the flow chart of FIG. 5, description will be made of an operation of the sheet material information detection apparatus 100 according to the first embodiment. The control illustrated in FIG. 5 is carried out in a case where the sheet material information detection apparatus 100 is mounted on the image forming apparatus 300 and the sheet material information detection is performed in synchronization with the timing of image formation.

As shown in FIG. 5, the operation of the sheet material information detection apparatus 100 is started (S11). The operation is started when, in the image forming apparatus 300 on which the sheet material information detection apparatus 100 is mounted, the sheet material processing operation is started.

Subsequently, from the control portion 120 of the image formation apparatus 300, sheet material transportation information is input to the control circuit 121 of the sheet material information detection apparatus 100 (S12). The sheet material transportation information relates to the position and velocity of the sheet material, and means the timing at which the sheet material passes the position of the sheet material information detection apparatus 100. In correspondence with the sheet material transportation information, the operation timing of the sheet material information detection apparatus 100 is determined. The sheet material transportation information is obtained by processing information to a signal of the sheet material passage sensor of the image forming apparatus 300, an operation start of the image forming apparatus 300 (pressing of a copy button), and the like.

Subsequently, on receiving the sheet material transportation information, the control circuit 121 starts controlling the sheet material information detection (S13). For example, first, the sheet material passage sensor which is provided at the upstream of the transport path 25 detects the passage of the sheet material, and then after a certain period of time has elapsed, a signal for starting the operation is sent from the control circuit 121 to the motor 5 of the sheet material information detection apparatus 100. In synchronization with the operation start of the motor 5, the measuring portion 17 starts the measurement.

Subsequently, the control circuit 121 detects the output of the measuring portion 17 to perform the measurement of the collision velocity (v0). The collision velocity (v0) is the speed of the motion member 1 immediately before the impact member 1 collides with the sheet material P. The measurement timing of the collision velocity (v0) is immediately before the start of the deceleration of the motion member 1 due to the collision with the sheet material (see FIG. 4).

Incidentally, in a case where the collision timing of the motion member 1 is clear, the measurement timing of the collision velocity (v0) may be determined by measuring time from releasing of the plate 2 by the cam 6. However, due to a difference in thickness of the sheet material, flapping thereof or the like, the moving distance of the motion member 1 until the motion member 1 collides with the sheet material varies, whereby there is a possibility that the timing determined by measuring time from the releasing of the plate 2 deviates from the actual collision timing. In this case, the collision velocity (v0) may be obtained by retroacting the measurement results after tracking and measuring the motion of the motion member 1 until the last process to determine the speed immediately before the start of the deceleration due to the collision.

Subsequently, the control circuit 121 determines whether or not the collision velocity (v0) is appropriate (S14). Whether or not the collision velocity (v0) is appropriate is determined according to whether or not the deviation from the designed collision velocity is within an allowable range. Further, also in a case where the deceleration due to the collision described above cannot be confirmed, the collision velocity is determined to be inappropriate. As a result, velocity abnormality due to a failure of a support mechanism or an acceleration mechanism of the motion member 1, transportation abnormality of the sheet material, and the like can be detected. Accordingly, a situation where an impact is applied under absence of a sheet material can be avoided. A determination mechanism is provided in the control circuit 121 of the sheet material information detection apparatus 100. Subsequent steps are divided into the following two cases according to determination results in this step.

In a case where the collision velocity is inappropriate (No in S14), the subsequent processes are suspended or sheet material information obtained in the subsequent processes are canceled (S17). The suspension of the subsequent processes means to avoid the collision of the motion member 1 with the sheet material. Specifically, as a desirable example, the motion member 1 is pulled up by instantaneously changing the rotation of the cam 6. The cancellation of the sheet material information obtained in the subsequent steps means to perform no sheet material information output.

After that, an abnormality information output indicating that the sheet material information detection apparatus 100 is in an abnormal state is performed (S18). The abnormality information is sent as a part of the sheet material information described later to the image forming apparatus 300, and is used for appropriate recovery. As an example, information can be displayed on a touch panel of the image forming apparatus 300 as failure information, or can be sent to an appropriate PC which is connected thereto, maintenance request destination, or the like through a network. It is more desirable to specify the cause of the abnormality while considering information of other sensors provided in the image forming apparatus 300.

For example, there is a case where, although the abnormality is sensed in the image forming apparatus 300, both of the sheet material passage sensors at the upstream and the downstream of the transport path 25 sense the passage of the sheet material. In this case, the control circuit 121 determines that the sheet material information detection apparatus 100 itself is in the abnormal state.

For example, in a case where although the sheet material passage sensor at the upstream senses the passage of the sheet material, the sheet material passage sensor at the downstream does not sense the passage of the sheet material, the control circuit 121 determines that there occurs jamming (also referred to as “jam”) of the sheet material.

After the output of the abnormality information, the operation of the sheet material information detection apparatus 100 ends (S19). At the end of the operation, the motion member 1 is returned to the stop position to get ready for restart.

On the other hand, in a case where the collision velocity (v0) is appropriate (YES in S14), detection of the sheet material information is performed (S15). The detection of the sheet material information is performed as described with reference to FIGS. 3A to 3D and 4. Desirably, the collision velocity (v0) is used as a reference, and a subsequent velocity change is converted into a relative value and used for the detection of the sheet material information.

Subsequently, the detected sheet material information is output (S16). The output of the sheet material information is performed with respect to the control portion 120 of the image forming apparatus 300. The sheet material information to be output has the following desirable modes.

(1) Information related to a motion velocity is directly output.

(2) Mechanical characteristics and physical values of the sheet material are calculated from the motion velocity and are output.

(3) Based on one of the items (1) and (2) above, the type and state of the sheet material is determined and output.

After the sheet material information is output, the operation of the sheet material information detection apparatus ends (S19). At the end of the operation, the motion member 1 is returned to the stop position to get ready for restart.

The sheet material information detection apparatus 100 includes the motion member 1 for collision with the sheet material, the acceleration mechanism for applying a predetermined velocity to the motion member 1, the support member 14 for supporting the sheet material, and the measuring portion 17 for measuring the motion of the motion member 1. Thereby, there can be provided the sheet material information detection apparatus 100 which detects information on characteristics related to the dynamic behavior of the sheet material and outputs the detected information. Further, the mechanical characteristics of the deflection deformation of the sheet material and the mechanical characteristics of the compression deformation thereof can be separately detected independently by one collision, and the velocity dependency of the mechanical characteristics can also be evaluated. Accordingly, it is not necessary to use sheet material information of low accuracy, and reliable identification of the sheet material supported by a plurality of sheet material informations can be performed, so that information useful for load application control in image formation and sheet material transportation can be obtained.

### Second Embodiment

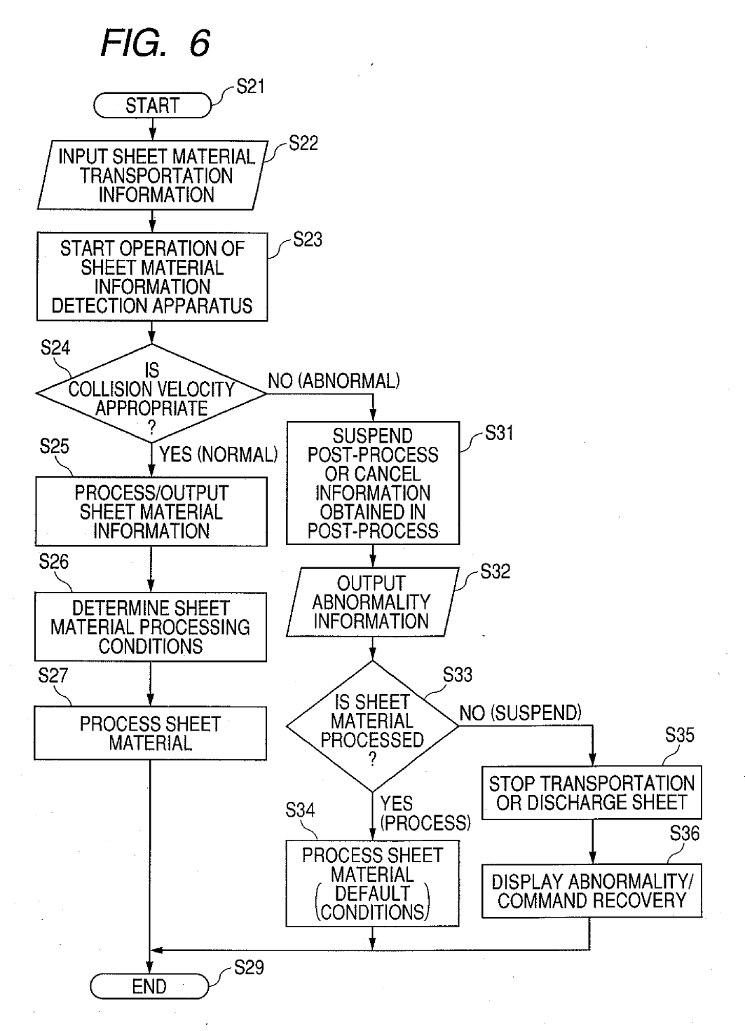

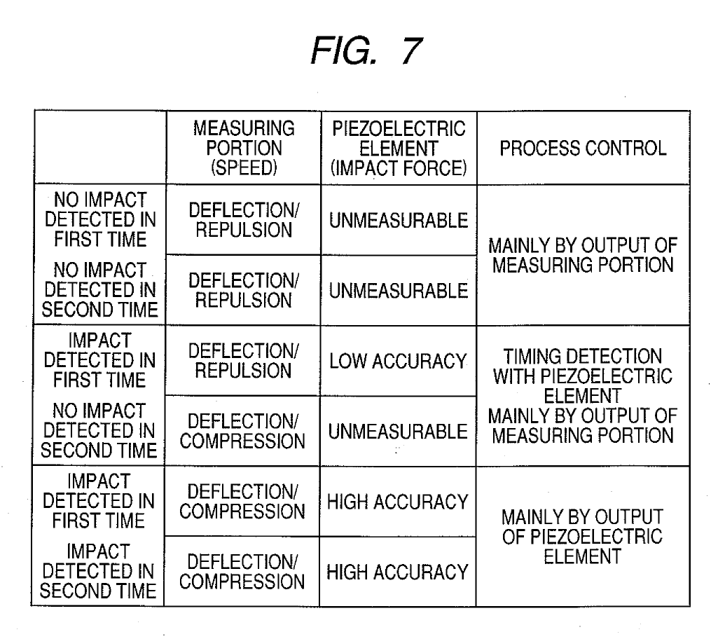

FIG. 6 is a flow chart of control of the sheet material processing apparatus according to a second embodiment of the present invention. FIG. 7 is a table of sheet material information outputs using a measuring portion and a piezoelectric element. In the second embodiment of the present invention, description will be made of control in a case where the sheet material information detection apparatus 100 described with reference to FIGS. 2 to 4 is mounted on a sheet material processing apparatus other than the image forming apparatus 300.

First, the sheet material processing apparatus starts a sheet material processing operation to start transporting a sheet material (S21). Starting of the sheet material processing operation is performed by a user (operator) of the sheet material processing apparatus pressing a start button on an apparatus main body, by sending a processing command from a peripheral equipment such as an external computer or a camera connected thereto, or the like.

Subsequently, the operation of the sheet material information detection apparatus 100 is started. The starting is performed, in the sheet material processing apparatus on which the sheet material information detection apparatus 100 is mounted, at the starting of the operation of the sheet material processing.

Subsequently, sheet material transportation information is input to the control circuit 121 of the sheet material information detection apparatus 100 (S22). The sheet material transportation information is related to the position and velocity of the sheet material, and serves to notify a timing at which the sheet material reaches a measurement position of the sheet material information detection apparatus 100. The timing of external force application or the like in the sheet material information detection apparatus 100 is determined in correspondence with the sheet material transportation information. The sheet material transportation information is obtained by processing information to, for example, a signal of a sheet material passage sensor of the sheet material processing apparatus, and the operation start of the sheet material processing apparatus.

Subsequently, on receiving the sheet material transportation information, the sheet material information detection apparatus 100 starts the operation of the sheet material information detection (S23). The control circuit 121 activates the motor 5 to hold up the motion member 1 and release the motion member 1, and the motion member 1 accelerated by the application spring 4 collides with the sheet material. The control circuit 121 tracks the outputs of the measuring portion 17 after the releasing to determine the collision velocity (v0: speed immediately before the velocity curve reaches an inflection point in FIG. 4).

The control circuit 121 determines whether or not the collision velocity (v0) is appropriate after starting the sheet material information detection operation (S24). In a case where the collision velocity (v0) is not appropriate (NO in S24), subsequent processes are suspended or sheet material information obtained in the subsequent processes are canceled (S31). Further, an abnormality information output indicating that the sheet material information detection apparatus 100 is in an abnormal state is performed (S32).

Subsequently, based on notification by the control circuit 121, the sheet material processing apparatus determines to either execute or suspend the sheet material processing (S33). In a case where the abnormality is minor (YES in S33), the sheet material processing is not necessarily suspended, so that the operation of the sheet material information detection apparatus 100 is stopped, and then the sheet material processing is executed under preset default conditions. The determination that the abnormality is minor is applied to a case where there can be recognized performance of normal transportation of the sheet material in the sheet material processing apparatus through the transport path 25. Further, the determination is also applied to a case where, in the repetitive sheet material processings, abnormality suddenly occurs at a low probability.

However, in a case where the influence of the abnormality is determined to be large (NO in S33), the sheet material processing is suspended (S35 and S36). In the suspension of the sheet material processing, transportation is stopped or the sheet material is discharged (S35). Further, the abnormality of the sheet material processing apparatus is displayed and appropriate recovery is commanded (S36). Further, as an occasion needs, the influence on the next sheet material processing is determined and an appropriate processing is performed. After this processing, the operation ends (S29).

Next, description will be made of a case where the collision velocity (v0) is appropriate (YES S24). In the sheet material information detection apparatus 100, the opposing member 15 receives the motion member 1 thorough the sheet material. With one rotation of the cam 6 driven by the motor 5, the motion member 1 is successively allowed to strike the surface of the sheet material twice. In the first strike, the motion member 1 compresses the application spring 4 by a large amount and protrudes, and collides with the sheet material at a high collision velocity (v0). In the subsequent second strike, the motion member 1 compresses the application spring 4 by a small amount and protrudes, and collides with the sheet material at a low collision velocity (v0).

Subsequently, the control circuit 121 forms sheet material information based on the output results of the measuring portion 17 and the output results of the piezoelectric element 16 in the two times collision processes and outputs the resulting sheet material information to the sheet material processing apparatus (S26).

In the sheet material processing apparatus, based on the sheet material information transmitted from the control circuit 121, sheet material processing conditions are determined, and based on the thus determined sheet material processing conditions, the sheet material processing such as image formation is performed (S27). In the sheet material processing apparatus, based on the sheet material information, a processing process is determined, in each step of the process, required control is performed. Particularly important control in the sheet material processing apparatus is control related to transportation of the sheet material. The load value of the transporting roller with respect to the sheet material having high rigidity is made larger. Further, in consideration of the velocity dependency of the mechanical characteristics of the sheet material, appropriate load application rate is determined. After this processing, the operation ends (S29).

As shown in the table of FIG. 7, there may be a case where, when the sheet material information detection apparatus 100 allows the motion member 1 to strike the sheet material twice, the impact force cannot be detected by the piezoelectric element 16. As described above with reference to FIG. 3, when the deflection resistance of the sheet material is large, the motion member 1 cannot allow the sheet material to retrocede to the opposing member 15 to apply the impact force on the piezoelectric element 16.

Therefore, when the impact force is detected by the piezoelectric element 16 in both the first strike and the second strike, the control circuit 121 outputs a peak value of the impact force in the first strike and a peak value of the impact force in the second strike to the sheet material processing apparatus. In the sheet material processing apparatus, with reference to a database in which results are categorized by combinations of the peak value of the impact force in the first strike and the peak value of the impact force in the second strike based on the output of the piezoelectric element 16, the sheet material is specified.

In this manner, in a case where a large impact force is applied to the piezoelectric element 16, the motion member 1 reaches the opposing member 15 at a high speed. As a result, the time in which the sheet material is deflected/compressed is short, so that the accuracy for velocity analysis using the output of the measuring portion 17 cannot be ensured with a normal processor. On the other hand, the peak value of the output of the piezoelectric element can be detected instantaneously with a simple circuit structure, so that the determination of the sheet material with high accuracy based on the output of the piezoelectric element 16 is possible.

In a case where a high-speed dedicated chip (digital signal processor: DSP) having sufficiently short sampling intervals is used, even in a high-speed collision process, the accuracy of the velocity analysis using the output of the measuring portion 17 can be ensured, but at high cost. Accordingly, all the collision processes can be evaluated based on the output of the measuring portion 17, but such evaluation is no so practical at present.

In a case where the impact force is detected only in the first strike of the two times of strikes, the peak of the impact force in the first strike is low, so that the determination accuracy is lowered only based on the output of the piezoelectric element 16. Therefore, the control circuit 121 measures the duration time of the compression deformation process of the sheet material described above by detecting the timing based on the output of the piezoelectric element 16, and extracts the collision velocities (v0 and v1) by analyzing the output of the measuring portion 17. Then, the measurement results of the compression deformation process are transmitted to the sheet material processing apparatus together with the measurement results of the deflection deformation process obtained based on the output of the measuring portion 17.

In a case where no impact force is detected in both the first strike and the second strike, no information is obtained from the output of the piezoelectric element 16. On the other hand, the sheet material receives the motion member 1 and slowly repulses, so that the deflection deformation process and the repulsion process of the sheet material can be tracked with high accuracy by using the output of the measuring portion 17. In this case, as described above with reference to FIGS. 3A to 3D and 4, the control circuit 121 performs velocity analysis of the output of the measuring portion 17, and extracts the duration time of the deflection deformation process. The velocity of the motion member 1 in the rebound process is measured and compared with the collision velocities (v0 and v1), and then the analysis results are transmitted to the sheet material processing apparatus.

As described above, according to the second embodiment of the present invention, there is provided the sheet material processing apparatus which can perform an appropriate sheet material processing based on the information to the characteristics related to the dynamic behavior of the sheet material. In particular, determination of the processing conditions appropriate for the mechanical processing such as transportation of the sheet material can be made and a trouble including jamming of the sheet material can be reduced.

### Third Embodiment

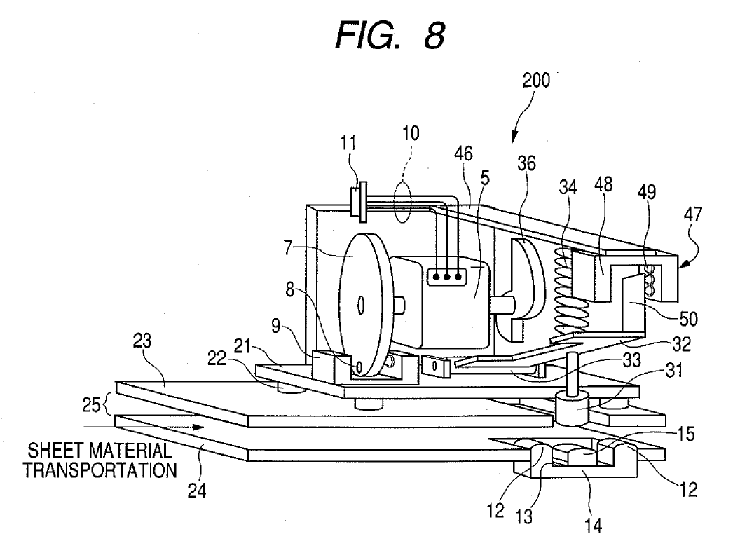

FIG. 8 is an explanatory view of a structure of a sheet material information detection apparatus according to a third embodiment of the present invention. A sheet material information detection apparatus 200 according to the third embodiment of the present invention includes, as main components thereof, a motion member 31 for collision with the sheet material, an acceleration unit for imparting a predetermined velocity to the motion member 31, a support member for supporting the sheet material, and a measuring unit for measuring a motion of the motion member 31. In the third embodiment of the present invention, the motion member 31 is allowed to collide with the sheet material through a rotational motion in which the motion member 31 is allowed to swing about a bearing 33. Further, for a measuring portion 47, a transmission optical sensor which is lower in cost than a laser Doppler velocimeter used in the first embodiment of the present invention is adopted. The measuring portion 47 has a structure in which a light shielding plate 50 moves between a light emitting portion 48 and a light receiving portion 49 and detects a change in light shielding state by the light shielding plate 50 caused by motion of the motion member 31. Other basic constructions are the same as those of the first embodiment of the present invention, so that in FIG. 8, the elements which are the same as those shown in FIG. 2 are identified by like numerals, and detailed descriptions thereof will be omitted. FIG. 8 schematically shows a state where a compressed application spring 34 is released and the motion member 31 is in a moving state.

As shown in FIG. 8, the motion member 31 for collision with the sheet material is fixed to one end of a plate 32 used for interlocking with an acceleration mechanism described later. A side opposite to the motion member fixed side of the plate 32 is pivotally supported by the rotational bearing 33. Thereby, the motion member 31 is freely movable in a direction of rotation about the bearing 33.

The acceleration mechanism for imparting the predetermined collision velocity to the motion member 31 includes the application spring 34 for imparting a force for acceleration, a cam 36 for controlling expansion and contraction of the application spring 34, and a motor 5 for driving the cam 36. The cam 36 is fixed to one end of an output shaft of the motor 5. The cam 36 compresses/releases the application spring 34. The cam 36 engages with an edge of a notch portion provided in a middle of the plate 32 to lift up the plate 32, thereby compressing and deforming the application spring 34. The cam 36 releases the engagement of the plate 32 during the rotation and allows the motion member 31 to be urged by the application spring 34 and to collide with the sheet material.

The application spring 34 is interposed between the plate 32 operated by the cam 36 and a support member 46 fixed to the housing 21 and is compressed/released by the movement of the cam 36. The application spring 34 is supported by a supporting member (not shown) so as to freely expand and contract without causing unnecessary bending.

A positioning mechanism used for adjusting the rotation angle of the motor 5 includes, as is the case with the first embodiment of the present invention, a positioning wheel 7 fixed to the other end of the output shaft of the motor 5 and a photointerruptor 9 for detecting a position. The motor 5 is supplied with a driving electric power through the electric wire 10 and the connector 11 from a driver (not shown).

The support member 14 for supporting the sheet material has the recess 13 between the two protrusions 12 arranged in front and rear sides in the sheet material transporting direction. The opposing member 15 is fixed to a position facing the motion member 31 of the recess 13.

The measuring portion 47 for measuring the motion of the motion member 31 has the light source 48 and the light receiving portion 49. The light source 48 and the light receiving portion 49 are disposed such that the motion of the motion member 31 can be detected along the motion direction. For compensation of the measurement, the light shielding plate (measurement assisting member) 50 for shielding light from the light source 48 is fixed to the plate 32 on the end thereof having the motion member 31 provided. The measuring portion 47 detects that the amount of light emitted from the light source 48 and incident on the light receiving portion 49 changes by the movement of the light shielding plate 50, thereby detecting the position and location of the motion member 1. The measuring portion 47 is fixed to the support member 46.

The motion member 31, the acceleration mechanism, and the measuring portion 47 are assembled on a housing 21 which is attached to the first transportation guide 23 through the damper 22. The transport path 25 is formed between the first transportation guide 23 and the second transportation guide 24. The support member 14 is attached to the second transportation guide 24 through a damper (not shown). The sheet material is transported in the transport path 25, reaches the sheet material information detection apparatus 200, and then receives the strike of the accelerated motion member 31. The sheet material information detection apparatus 200 has the above-mentioned structure and performs a detection operation in the same manner as that of the sheet material information detection apparatus 100 according to the first embodiment of the present invention.

According to the third embodiment of the present invention, there can be provided the sheet material information detection apparatus 200 for detecting and outputting information to the characteristics related to the dynamic behavior of the sheet material. The deflection deformation process and the compression deformation process of the sheet material are detected, and sheet material information which reliably reflects the mechanical characteristics can be output. Further, the velocity dependency of the mechanical characteristics of the sheet material can be detected, so that sheet material information useful for the load application control in the sheet material processing can be output. Further, the motion member 31 is supported so as to freely rotate, thereby making rotation resistance small and stably suppressing variations in the collision motion. Therefore, the detection error of the sheet material information is reduced and the durability of the motion member 31 increases. As a result, there can be provided a sheet material processing apparatus which can perform appropriate sheet material processing based on the information to the characteristics related to the dynamic behavior of the sheet material. In particular, processing conditions appropriate for the mechanical processing such as transportation of the sheet material can be determined, so that troubles such as jamming of the sheet material can be reduced.

### (Sheet Material Information Detection Apparatus According to Modified Example)

As shown in FIG. 2, in the sheet material information detection apparatus 100 according to the first embodiment of the present invention, the motion member 1 to which a predetermined collision velocity is imparted by the acceleration mechanism is allowed to collide with the sheet material supported by the support member 14. In the collision process, the motion member 1 collides with the sheet material, thereby imparting a dynamic deformation such as deflection and compression to the sheet material, and motions such as acceleration and deceleration of the motion member 1 in each stage of the process are measured by the measuring portion 17. In particular, the collision velocity (v0) at the moment when the motion member 1 collides with the sheet material and the amount of deceleration received by the motion member 1 in a dynamic deformation process of the sheet material are detected and the dynamic behavior of the sheet material is output as the sheet material information. Further, as occasion needs, the sheet material information on the dynamic behavior may be processed to derive and output a mechanical constant such as a spring constant of deflection or compression of the sheet material, a physical value such as Young's modulus, or various information on kinds, state, or the like of the sheet material which correlate with the mechanical constant and the physical value to a large extent. The amount of water which has a great influence on the mechanical properties can also be calculated.

The motion member has a predetermined mass and performs load application through collision with the sheet material. For the motion member, one which causes no deformation or backlash at the time of collision is used. The material and shape of the motion member are preferably such that the wear resulting from collision with the sheet material or contact involved therein, plastic deformation, and elastic deformation are minimum, the toughness is high, and no crack is generated. Specifically, as the material therefor, a metal material such as stainless steel is desirable.

It is desirable that the motion member has a spherical shape or a rod shape and has a curved surface at a distal end portion thereof for collision with the sheet material. By forming the distal end portion into the curved surface, even in a case where the collision angle is varied due to vibration of the motion member or of the sheet material at the time of collision, stable impact application is possible, and local wear is reduced to attain uniform wearing of the surface. The curved surface may be partially provided with a flat portion. By allowing the flat portion to collide with the sheet material, the sheet material of the collision portion is uniformly compressed, so that an error resulting from uneven density of the sheet material can be reduced.

When the motion member is in contact with the sheet material at the time of collision, it is desirable that the mechanical connection thereof to other members or the periphery is small. Examples of the mechanical connection include direct friction between members, mutual action between members by a magnetic force, an electrostatic force, or the like, and viscous resistance through a fluid such as air or liquid. In general, an acting force due to the mechanical connection has nonlinearity with respect to the velocity of the motion member. Therefore, in a signal processing for analyzing the characteristics of a sheet material based on the measured motion, complicated analysis is required.

Incidentally, those mechanical connections whose influence on the velocity of the motion member is relatively simple, for example, connection by a spring force or influence by gravity are acceptable, because the action force is substantially linear, and because action force components can be easily removed by the signal processing.

The motion member is supported such that mechanical connection to members other than the sheet material is as small as possible and smooth motion is available at the time of collision. The motion of the motion member is desirably a linear operation or a rotation operation. For supporting the motion member, the bearing capable of the rotation described in the third embodiment of the present invention can be used because in general, the bearing has a small moving resistance thereby being stable, and because the variation in the motion thereof is small.

Further, the motion member is desirably provided with a measurement assisting member such that the measurement of the motion by the measuring unit is facilitated. Examples of the measurement assisting member include a reflection plate, a shielding plate, and a scale in a case where the measuring unit is an optical unit.

The acceleration mechanism imparts a predetermined velocity to the motion member. The combination of the acceleration mechanism and the motion member is determined in consideration of the gravity, vibration, influences of various motion resistances such that the collision velocity (v0), that is, the velocity of the motion member at the time of first contact during the process of collision with the sheet material is optimum.

The collision velocity (v0) is appropriately determined within such a range that the motion member does not leave an impression or the like on the sheet material, in view of the rigidity of the sheet material. The acceleration at the time of collision is desirably as small as possible. Even in a case where a moving distance of the motion member until the collision is varied due to variations in the thickness of the sheet material, fixation accuracy of the sheet material information detection apparatus 100, and the like, collision at a stable velocity is possible. Although depending on the collision velocity (v0), the desirable acceleration is such that the variation in velocity is within the range of 5% or less, more preferably 1% or less for the moving distance of 1 mm.

In order to reduce the acceleration, acceleration by an acceleration mechanism and acceleration/deceleration by gravity are used so as to appropriately compensate for each other. The motion of the motion member imparted by the acceleration mechanism is desirably restricted to one axial direction as far as possible from the viewpoint of simplification of measurement of the motion of the motion member in the post-process and analysis thereof. From this viewpoint, the linear motion described in the first embodiment of the present invention is the most desirable.

Further, a rotating motion for swinging the motion member about a rotation axis is also desirable. In this case, it is desirable that the rotation radius is made as large as possible to suppress an angular deviation resulting from a deviation of a collision position. Considering the above, according to a most desirable example of the acceleration mechanism, a coil spring is used as the application spring, and the spring stores energy for acceleration by being compressed and imparts motion energy to the motion member by being released, thereby performing acceleration. In order to compress and release the application spring, a cam and a motor can be used. Further, another desirable example of the acceleration mechanism is a magnetic mechanism such as a solenoid.

The collision as described above can be performed once for one sheet material information detection, and can desirably be performed a plurality of times. In a case where the collision is performed a plurality of times, it is also desirable that an impact force of the same value be applied every time, thereby equalizing the output value to increase the accuracy. More desirably, the motion member is allowed to collide with the sheet material a plurality of times at least two different collision velocities. Thereby, the dependency on load application velocity of the behavior of the sheet material is measured, and information to the viscoelasticity of the sheet material can be extracted. Accordingly, the motion member can be provided with a velocity changing mechanism for imparting at least two different collision velocities. According to a desirable example of the velocity changing mechanism, in the acceleration mechanism including the application spring, the cam, and the motor, the cam has a plurality of lifts, and a plurality of different amounts of compressions are given to the application spring and different velocities are imparted at the time of release. The plurality of times of collisions may be performed at the same time in a plurality of positions on the sheet material, or may be performed at given time intervals. By performing the collisions at a plurality of positions on the sheet material to detect information, occurrence of a plurality of times of collisions at the same position can be avoided, so that the detection can be prevented from being influenced by a deformation of the sheet material caused by the first collision.

The structure for supporting the sheet material has a function of supporting the sheet material by the contact thereof with a part of the sheet material and allowing the support point for the sheet material to serve substantially as a fixed end. More desirably, the structure can support the sheet material such that the sheet material can be deflected by the collision of the motion member therewith. A specific example thereof is the support member 14 of high rigidity according to the first embodiment of the present invention, having the groove structure formed by the protrusions 12 and the recess 13. As the function of the structure, the protrusions 12 and the sheet material are brought into contact with each other and the sheet material is supported by a frictional force therebetween, and the sheet material is deflected and deformed into the inside of the recess 13 by the collision of the motion member 1. Further, if necessary, there may be separately provided a supporting member which comes into press contact with the protrusions 12 through the sheet member so that the supporting member firmly supports the sheet material by interposing the sheet material between the supporting member and the protrusions 12.

Desirable modes of the method of supporting the sheet material include a cantilever type mode by which the sheet material is supported at one point or on one straight line and the impact is given to a free end side, and a twin type mode by which the sheet material is supported at two points or on two straight lines and the impact is given between the two supported portions. Particularly in a case where paper is used as the sheet material or the like, in the cantilever supporting or twin supporting, in which two or less support portion is provided, the supporting is influenced by the anisotropy of the characteristics resulting from chain-lines of the sheet material. In order to avoid this, the support portions are provided in three or more positions and the motion member is allowed to collide between the support portions, or the sheet member is supported at a periphery thereof and the motion member is allowed to collide with the inside thereof.

Further, it is preferable that an impact reception member which collides with the motion member through the sheet material is provided. The impact reception member is a pedestal which receives the force applied by the motion member to the sheet material, for generating the compression deformation in the sheet material interposed between the impact reception member and the motion member. The term “compression deformation” herein employed refers to a deformation in the thickness direction of the sheet material caused by a force applied in the same thickness direction. Specifically, the impact reception member is the opposing member 15 of high rigidity according to the first embodiment of the present invention, which has a flat surface or moderately curved surface on the surface facing the motion member 1. A part of the support member described above may be used as the opposing member. For example, the recess 13 having the groove structure may also serve as the opposing member.

It is also desirable that a pressure sensitive sensor such as a piezoelectric element is attached to the support member and the opposing member. As a result, the contact of the sheet material and the collision of the motion member can be sensed. Therefore, auxiliary information for obtaining information, such as setting of data obtaining timing of the measuring portion, can be obtained.

The measuring portion for measuring the motion of the motion member performs measurement for at least a part of the acceleration and deceleration of the motion member in the moving process of the sheet material. That is, in the process in which the motion member to which the predetermined velocity is imparted by the acceleration mechanism collides with the sheet material to give the sheet material the dynamic deformation such as a deflection deformation or a compression deformation, the velocity or position of the motion member is measured. A desirable object to be measured is a change in position of the motion member according to time, velocity of the motion member, and in particular, one allowing precise measurement of a change in velocity from immediately before the collision and while the motion member is in contact with the sheet material. More desirably, an object to be measured allows tracking of a change in velocity from the state where the motion member is in contact with the sheet material to the state where the motion member is spaced apart therefrom due to repulsion of the sheet material. Further, another desirable requirement is that the mechanical connection of the measuring portion to the motion member is small. According to the above-mentioned requirements, an optical detection device is desirable for the measuring unit.

As the optical detection device, for example, there may be used a transmission optical sensor which has a light emitting portion and a light receiving portion, and is provided with a motion member provided in an optical path between the light emitting portion and the light receiving portion or a light shielding plate provided to the motion member, for detecting that a light shielding state is changed by the motion of the motion member.

As another example, there may be used a reflecting device which has a light emitting portion and a light receiving portion, and performs measurement from reflection of light applied to the motion member or to the reflecting plate provided to the motion member. With this structure, there can be used a method of measuring velocity by tracking markings or a scale provided on the reflecting plate and the motion can be measured by a reflected light amount. Further, more desirably, a laser Doppler velocimeter is used to measure the velocity of the motion member with higher accuracy by interference of reflected light.

Examples of the sheet material include paper (plane paper, glossy paper, coated paper, recycled paper, or the like), a film of a resin or the like, and an OHT sheet and are mainly directed to sheet-shaped image recording media. The shape of the sheet material may be any shape such as one obtained by being cut into predetermined dimensions (cut paper) or one rolled in a roll shape (roll paper). Further, the sheet material may be a single material or a sheet material obtained by bonding two or more sheet materials to each other. Herein, description is made of a sheet material cut into predetermined dimensions as an example.

The sheet material information includes all the information related to the sheet material required for the sheet material processing. Particularly important elements include the physical properties and shape, and various informations related thereto. Examples of such informations includes the thickness, density, elastic modulus, viscosity, vibration characteristic, unevenness, surface roughness, state, deformation state, strength, easiness of elastic deformation/plastic deformation, stretch amount, color tone, color change, reflectance, deformation (stretching, bending, crushing, damaging, folding, etc.), transmittance, state of curling, gas/liquid permeability, thermal properties such as heat diffusivity or heat capacity of the sheet material. In a case of using paper, examples of informations include information to unevenness of fibers, filler amount, coating layer, or the like.

Further, the water content gives a great influence to the physical properties and shape of the sheet material and is a particularly important attribute. Another important sheet material information is information to an embedded matter which affects the physical properties. Examples of the embedded matter include elements such as an ID tag and natural objects such as pressed flowers and leaves. Other examples of the important sheet material information include information to an image which has been formed, adhesion of a foreign matter, dirt, size and shape of media, folding at an end portion or the like, a working state such as cutting or drilling, lamination or coating, adhesion of a staple, or the like. Further, there are also other examples of the important information including bonding of some pieces of media to each other in an in-plane direction, and whether or not two or more of them entirely or partially overlap each other.

Example of the sheet material processing apparatus include an image forming apparatus for recording characters, images, or the like onto a sheet material, such as a copying machine, a laser beam printer, an inkjet printer. In the representative image forming apparatus at present, as part of the processing step, curl correction, stacking, sorting for bookbinding, punching, stapling, or the like are generally performed. As described above, the term “sheet material processing” herein employed refers to overall processes carried out until a medium which is set is discharged from an image forming apparatus.

Further, other examples of the sheet material processing include reading a content recorded on a sheet material. The content recorded on a sheet material may be of any kind or form, so that the content may be provided in a form of images or characters, stamps, magnetically recorded data, data recorded on an embedded ID tag, or the like.

Further, other examples of the sheet material processing apparatus include an apparatus which transports a sheet material and reads information recorded on the sheet material (so-called document scanner or the like), a feeding device for paper currency, tickets, or the like, and various working apparatuses for performing working such as folding or drilling of a sheet material.

In the sheet material processing apparatus, based on sheet material information obtained in the sheet material information detection apparatus, processing conditions for the sheet material are modified, adjusted, or controlled. In particular, the information to the characteristics related to the dynamic behavior of the sheet material, such as the deflection deformation or the compression deformation thereof, is effectively used for a processing condition control for a process, such as transportation of the sheet material or pressure application at the time of fixation of a coloring material, in which a mechanical operation involving load application for deflecting or compressing the sheet material is performed.

The information to the characteristics related to the dynamic behavior of the sheet material, such as the deflection deformation or the compression deformation thereof, is highly relevant to various attributes of paper. Therefore, there are many other processing conditions under which control can be performed in a desirable manner. Example of the processing conditions includes image forming conditions related to transfer of a coloring material mainly including toner for electrophotography and an ink for an inkjet printer to the media. That is, according to the sheet material information, the image forming conditions is changed, control conditions for the image formation is changed, or the like, thereby enabling adjustment of the image forming conditions. For example, a thickness is estimated and derived from deflection performance of the sheet material. Image formation for a sheet material having a small thickness is performed in a mode appropriate for thin paper, and image formation for a sheet material having a large thickness is performed in a mode appropriate for thick paper.

Another desirable example of control for the image forming conditions includes, first, adjustment of a transferring amount of a coloring material. The transferring amount indicates, for example, a supplying amount of the toner to the media, or an adhesion amount of the ink thereto. Desirable examples include, second, adjustment of fixing conditions of the coloring material. The fixing conditions include a fixing temperature and a fixing pressure. In the sheet material processing apparatus, the sheet material processing is performed under the sheet material processing conditions determined as described above. Incidentally, the sheet material processing conditions are not limited to the conditions described above.

The determination of the sheet material processing conditions is performed by a processor which processes input date to determine the operation of the sheet material processing apparatus. The processor may be provided to any one of an inside of the image forming apparatus, an inside of the sheet material processing apparatus, and the sheet material information detection apparatus. Alternatively, the function of the processor may be performed by an external computer or the like.

In the sheet material information detection apparatus, in a case where a state is determined as an abnormal state because an output value exceeds a certain threshold value range, an abnormality signal may be desirably output. In this case, with reference to outputs of other sensors of the sheet material processing apparatus, an input value of a user, or the like, a subsequent processing is determined. For example, in a case where the abnormality is determined to be minor, it is desirable that appropriate standard conditions for the sheet material processing is determined in advance, and the sheet material processing is performed under the standard conditions. Further, in a case where the abnormality is determined to be serious, the sheet material processing may be paused or stopped. In either case, appropriate information is desirably provided to a user through emission of warning, indication of information related to repair work, or the like.

The sheet material information detection apparatus 100 according to the first embodiment of the present invention includes the motion member 1 which is supported so as to be movable and is provided with a collision surface for collision with the sheet material, and the support member 14, provided so as to face the impact surface, for supporting the sheet material. The motion member 1 is allowed to collide with the sheet material supported by the support member 14. The sheet material information detection apparatus 100 further includes the measuring portion 17 for detecting the velocity of the motion member 1 in the collision process in which the motion member 1 collides with the sheet material, and the control circuit 121 which detects an output of the measuring portion 17 and outputs the sheet material information.

In the sheet material information detection apparatus 100, the behavior of the sheet material surface to which an impact has been applied is tracked by the motion member 1 to be picked up as the velocity of the motion member 1 by the measuring portion 17. Accordingly, the momentum (velocity×mass) in a case where the motion member 1 collides with the sheet material and the behavior (such as deformation amount, deformation time, deformation process, and impact time) of the sheet material surface due to the impact can be detected directly and correctly.

The measuring portion 17 according to the first embodiment of the present invention is a laser Doppler velocimeter for detecting the velocity of the motion member 1 every second. The measuring portion 47 according to the third embodiment of the present invention is an optical sensor for optically detecting the position of the motion member 31 every second.

The motion member 1 according to the first embodiment of the present invention is supported so as to be linearly movable. The motion member 31 according to the third embodiment of the present invention is supported so as to be rotatable.

The support member 14 according to the first embodiment of the present invention supports the sheet material such that the sheet material can be deflected and deformed due to the collision of the motion member 1. The support member 14 includes the opposing member 15 for receiving the motion member 1 through the sheet material which is deflected and deformed, and the piezoelectric element 16 for detecting the impact force acting on the opposing member 15 in the process of receiving the motion member 1.

The control circuit 121 according to the first embodiment of the present invention detects, based on an output of the piezoelectric element 16, start of the compression process of the sheet material in the collision process, and outputs the sheet material information based on an output of the measuring portion 17 in the compression process.

The piezoelectric element 16 according to the first embodiment of the present invention detects an impact force in the collision process having a deflection resistance of the sheet material subtracted therefrom. The control circuit 121 detects, based on the output of the piezoelectric element, the start of the compression process of the sheet material in the collision process, and outputs the sheet material information based on the output of the measuring portion 17 in the compression process and the impact force detected by the piezoelectric element 16.

The piezoelectric element 16 according to the first embodiment of the present invention detects the impact force in the collision process having the deflection resistance of the sheet material subtracted therefrom. In a case where a peak value of the impact force exceeds a predetermined threshold value, the control circuit 121 outputs the sheet material information based on the detected impact force.

The control circuit 121 according to the first embodiment of the present invention, at least two kinds of collision velocities are set by controlling the application spring 4, and the motion member 1 is allowed to successively collide with the sheet material a plurality of times.

The image forming apparatus 300 includes the sheet material information detection apparatus 100 and the image formation process portion 340 which processes the sheet material whose sheet material information is detected by the sheet material information detection apparatus 100. The image forming apparatus 300 further includes the control portion 120 for adjusting the processing conditions for the sheet material in the image formation process portion 340 based on the sheet material information.

The sheet material information detection apparatus 100 performs a first step of accelerating, toward a sheet material, the motion member 1 supported so as to be movable toward the surface of the sheet material, and allowing the motion member 1 to collide therewith. Next, the sheet material information detection apparatus 100 performs a second step of detecting at least one of position and velocity of the motion member 1 after collision with the sheet material, and outputting the sheet material information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-170769, filed Jun. 20, 2006, which is hereby incorporated by reference herein in its entirety.

1. A sheet material information detection apparatus, which comprises a motion member movably supported and having a collision surface, formed thereon, for colliding with a sheet material, and a support member for supporting the sheet material so as to face the collision surface, in which the motion member is allowed to collide with the sheet material supported by the support member, the apparatus further comprising a motion detection unit for detecting at least one of position and velocity of the motion member during a process of collision with the sheet member, and an output unit for detecting an output of the motion detection unit during the collision process and outputting sheet material information.

2. The sheet material information detection apparatus according to claim 1, wherein the motion detection unit is an optical sensor for optically detecting the position of the motion member every second.

3. The sheet material information detection apparatus according to claim 1, wherein the motion detection unit is a laser Doppler velocimeter for detecting the velocity of the motion member every second.

4. The sheet material information detection apparatus according to claim 1, wherein the motion member is supported so as to be linearly movable or rotatable.

5. The sheet material information detection apparatus according to claim 1, wherein the support member supports the sheet material such that the sheet material is deflectable and deformable due to the collision of the motion member, which further comprises an impact reception member for receiving the motion member through the sheet material which is deflected and deformed, and an impact detection unit for detecting an impact force acting on the impact reception member when receiving the motion member.

6. The sheet material information detection apparatus according to claim 5, wherein the output unit detects start of compression of the sheet material during the collision process based on an output of the impact detection unit and outputs sheet material information based on an output of the motion detection unit during a compression process.

7. The sheet material information detection apparatus according to claim 5, wherein the impact detection unit detects an impact force during the collision process having a deflection resistance of the sheet material subtracted therefrom; and the output unit detects start of compression of the sheet material during the collision process based on an output of the impact detection unit and outputs sheet material information based on an output of the motion detection unit during a compression process and the impact force detected by the impact detection unit.

8. The sheet material information detection apparatus according to claim 5, wherein the impact detection unit detects an impact force during the collision process having a deflection resistance of the sheet material subtracted therefrom; and the output unit outputs sheet material information based on the detected impact force when a peak value of the impact force exceeds a predetermined threshold value.

9. The sheet material information detection apparatus according to claim 1, further comprising an acceleration mechanism which allows at least two kinds of collision velocities to be set.

10. A sheet material processing apparatus, comprising:
the sheet material information detection apparatus set forth in claim 1;
a processing unit for processing a sheet material whose sheet material information is detected by the sheet material information detection apparatus; and
an adjusting unit for adjusting processing conditions for the sheet material in the processing unit based on the sheet material information.

11. A sheet material information detection method, comprising:
accelerating, toward a sheet material, a motion member supported to be movable toward a surface of the sheet material and allowing the motion member to collide with the sheet material; and
detecting at least one of position and velocity of the motion member after the collision with the sheet material and outputting sheet material information.
